(19) United States
(12) Patent Application Publication
(10) Pub. No.: US 2026/0263882 A1
(43) Pub. Date: Sep. 10, 2026

(54) STORAGE CONTAINER FOR STORING PERSONAL ITEMS AND GOLF ACCESSORIES IN A GOLF CART AND METHOD THEREFOR

(71) Applicant: Dereck Jaggers, Chicago, IL (US)

(72) Inventor: Dereck Jaggers, Chicago, IL (US)

(21) Appl. No.: 19/075,316

(22) Filed: Mar. 10, 2025

(51) Int. Cl. A63B 57/20; A45C 11/24; A45C 13/02; A45C 15/00; H02J 7/00; H02J 50/10

(52) U.S. Cl. CPC A63B 57/20; A45C 11/24; A45C 13/02; A45C 15/00; H02J 7/70; A63B 2225/685; A63B 2225/687; H02J 50/10

(57) ABSTRACT

A storage container for storing personal items and golf accessories in a golf cart includes a bottom wall, a perimeter wall, a lid, a plurality of dividers, a wireless charger, and a magnetic mount. The perimeter wall extends from the bottom wall. The perimeter wall surrounds a storage space. The lid is pivotably connected to the perimeter wall to open and close the storage space. The dividers are positioned in the storage space to divide the storage space into compartments for personal items and golf accessories. The wireless charger is positioned in one of the compartments. The wireless charger is designed to wirelessly charge a personal electronic device placed on the wireless charger. The magnetic mount is positioned on the bottom wall. The magnetic mount is designed to magnetically couple to a metallic portion of a golf cart.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT NOT APPLICABLE

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to storage container and more particularly pertains to a new storage container for storing personal items and golf accessories in a golf cart. Many golfers take multiple personal items and golf accessories with them when golfing and just place them in the tray or compartment in the front dash of the golf cart. This can be messy and risk loss or damage of items, which can be expensive, such as electronics and jewelry. The new storage container provides a single storage space that is portable and securable to the golf cart to safely store many different personal items and golf accessories. It should be noted that while the new storage container is designed for use with golf carts and to store golf accessories, the new storage container could possibly be used to store items and accessories during other activities, both indoor and outdoor.

### (2) Description of Related Art Including Information Disclosed Under 37 CFR 1.97 and 1.98

The prior art relates to storage containers. The prior art, as best understood, does not disclose a storage container with a hinged lid, wherein the container has a plurality of internal compartments for holding various personal items and golf accessories, and contains magnets formed within the base which allows the device to be coupled to a golf cart.

### (H) BRIEF SUMMARY OF THE INVENTION

An embodiment of the disclosure meets the needs presented above in a storage container generally comprising a bottom wall, a perimeter wall, a lid, a plurality of dividers, a wireless charger, and a magnetic mount. The perimeter wall extends from the bottom wall. The perimeter wall surrounds a storage space. The lid is pivotably connected to the perimeter wall to open and close the storage space. The dividers are positioned in the storage space to divide the storage space into compartments for personal items and golf accessories. The wireless charger is positioned in one of the compartments. The wireless charger is designed to wirelessly charge a personal electronic device placed on the wireless charger. The magnetic mount is positioned on the bottom wall. The magnetic mount is designed to magnetically couple to a metallic portion of a golf cart.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a storage container according to an embodiment of the disclosure.

FIG. 2 is a top view of an embodiment of the disclosure.

FIG. 3 is a bottom view of an embodiment of the disclosure.

FIG. 4 is a side view of an embodiment of the disclosure.

FIG. 5 is a front view of an embodiment of the disclosure.

FIG. 6 is a side view of an embodiment of the disclosure in use.

### (J) DETAILED DESCRIPTION OF THE INVENTION

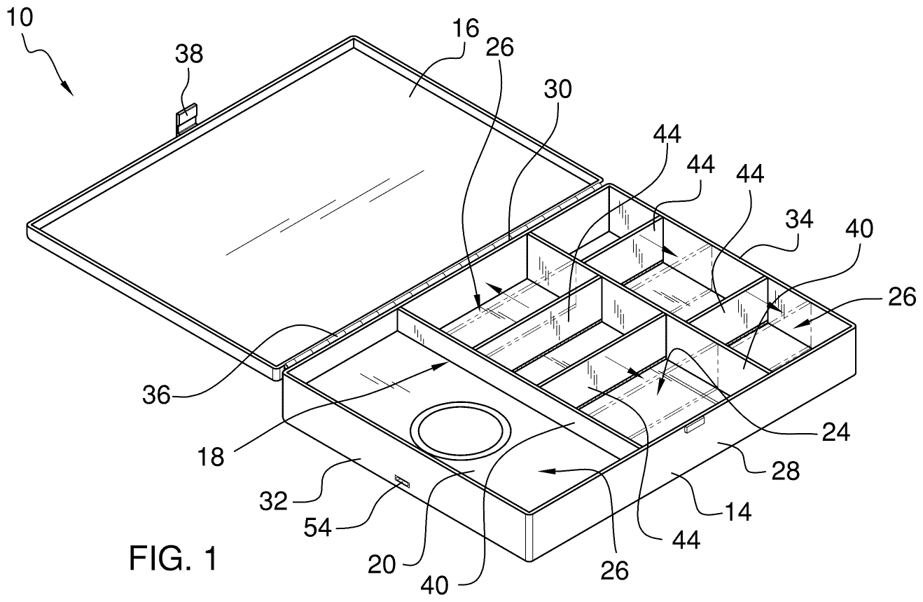

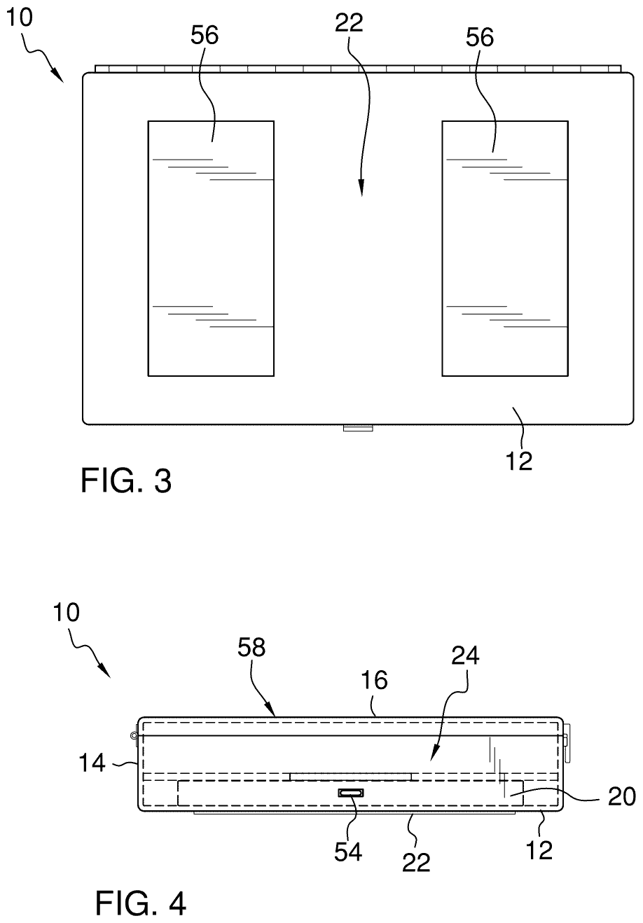

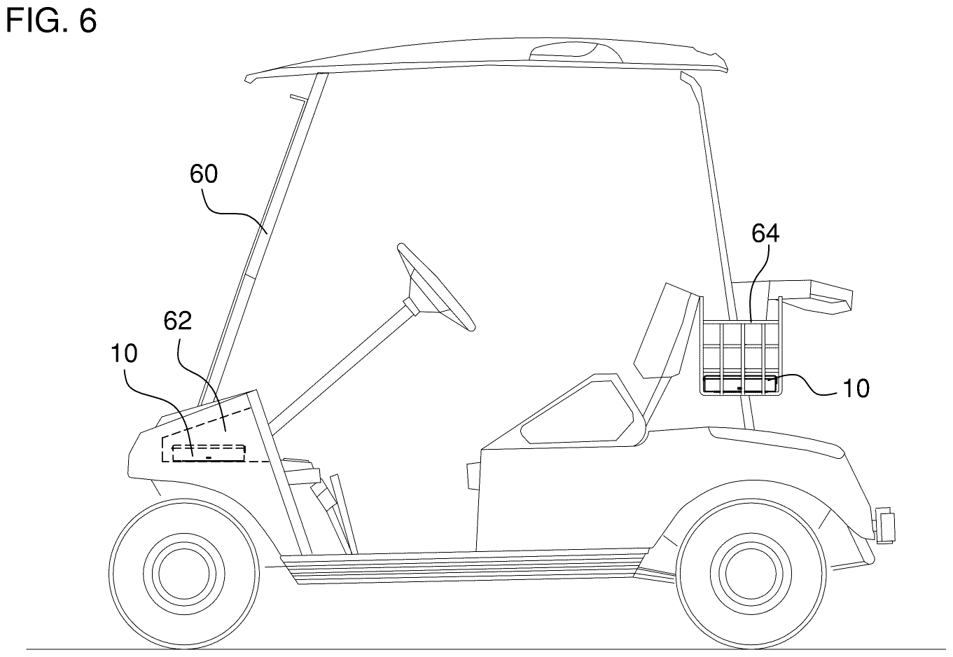

With reference now to the drawings, and in particular to FIGS. 1 through 6 thereof, a new storage container embodying the principles and concepts of an embodiment of the disclosure and generally designated by the reference numeral 10 will be described.

As best illustrated in FIGS. 1 through 6, the storage container 10 for storing personal items and golf accessories in a golf cart 60 generally comprises a bottom wall 12, a perimeter wall 14, a lid 16, a plurality of dividers 18, a wireless charger 20, and a magnetic mount 22. The perimeter wall 14 extends from the bottom wall 12. The perimeter wall 14 surrounds a storage space 24. The lid 16 is pivotably connected to the perimeter wall 14 to open and close the storage space 24. The dividers 18 are positioned in the storage space 24 to divide the storage space 24 into compartments 26 for personal items and golf accessories. The wireless charger 20 is positioned in one of the compartments 26. The wireless charger 20 is designed to wirelessly charge a personal electronic device placed on the wireless charger 20. The magnetic mount 22 is positioned on the bottom wall 12. The magnetic mount 22 is designed to magnetically couple to a metallic portion of a golf cart 60.

In the exemplary embodiment, the perimeter wall 14 is rectangular and includes a front wall panel 28, a back wall panel 30, a first side wall panel 32, and a second side wall panel 34. However, other shapes, such as square or rounded, are within the scope of the disclosure. Each of the first side wall panel 32 and the second side wall panel 34 is positioned perpendicular to and connects the front wall panel 28 and the back wall panel 30. The lid 16 is pivotably attached to the back wall panel 30, such as by a hinge 36 or hinges, though the lid 16 could be attached to the front wall panel 28, the first side wall panel 32, or the second side wall panel 34. The lid 16 includes a clasp 38 to secure the lid 16 in place when closed, or possibly snaps or a zipper. In one possible embodiment, the storage container 10 could include a lock for security.

In the exemplary embodiment in FIG. 1, the dividers 18 include one or more stationary dividers 40 and a plurality of movable dividers 44. In the exemplary embodiment, there is a first stationary divider 41 and a second stationary divider 42, though in other possible embodiments there could be one stationary divider or more three or more stationary dividers 40. The stationary dividers 40 are positioned to extend across the storage space 24. The stationary dividers 40 are attached to opposing panels of the perimeter wall 14. In the exemplary embodiment, the first stationary divider 41 and the second stationary divider 42 are positioned perpendicular to and extend between the front wall panel 28 and the back wall panel 30. In another possible embodiment, the first stationary divider 41 and the second stationary divider 42 could extend between the first side wall panel 32 and the second side wall panel 34.

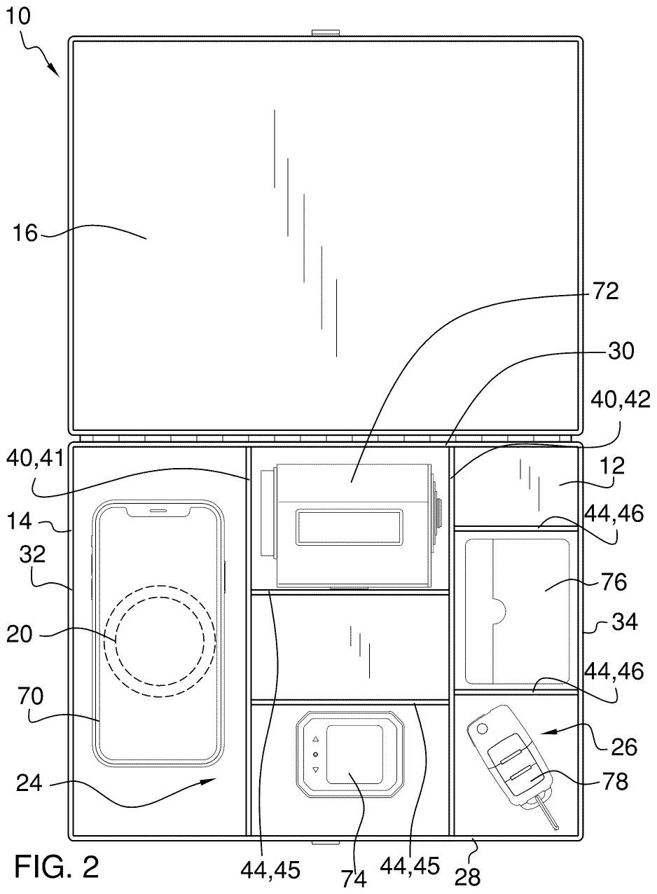

Each of the movable dividers 44 is movable with respect to the perimeter wall 14 and the stationary dividers 40 to selectively adjust a size of each of the compartments 26 formed in part by the movable dividers 44. In the exemplary embodiment shown in FIG. 2, the movable dividers 44 include central dividers 45 positioned perpendicular to and between the first stationary divider 41 and the second stationary divider 42 and side dividers 46 positioned perpendicular to and between the second stationary divider 42 and the second side wall panel 34. In the exemplary embodiment, each of the central dividers 45 is greater in width than each of the side dividers 46. However, in another possible embodiment, the central dividers 45 could have the same or lesser width than the side dividers 46.

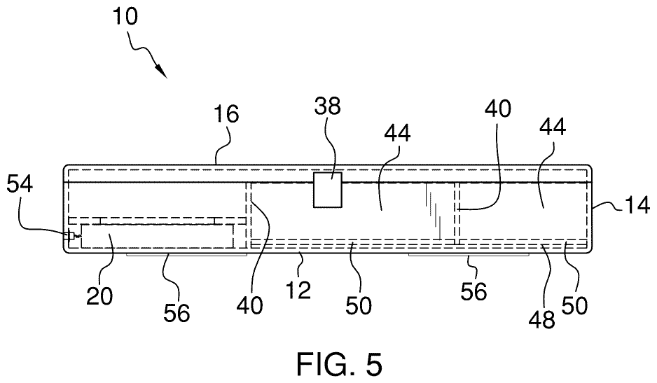

In the exemplary embodiment shown in FIG. 5, the bottom wall 12 includes a magnetic plate 48 extending under the movable dividers 44. Each of the movable dividers 44 includes a magnetic portion 50 designed to magnetically couple to the magnetic plate 48 of the bottom wall 12 such that the movable dividers 44 are selectively positionable on the bottom wall 12. The movable dividers 44 could be selectively positionable in other ways, such as being slidable in guide tracks or insertable in a plurality of grooves formed in the stationary dividers 40.

The wireless charger 20 is positioned between the first stationary divider 41 and the first side wall panel 32. The wireless charger 20 includes a battery 52 and a charge port 54 connected to the battery 52. The charge port 54 is positioned in the perimeter wall 14. The wireless charger 20 is attached to at least one of the bottom wall 12 and the perimeter wall 14. As shown in FIG. 1 and FIG. 5, the wireless charger 20 is designed to occupy approximately half of its respective one of the compartments 26, such that a mobile phone is positionable on the wireless charger 20 and under the lid 16 when closed, as shown in FIG. 2.

The magnetic mount 22 includes a pair of magnetic strips 56 attached to the bottom wall 12. In another possible embodiment, the magnetic mount 22 could be a single large magnetic panel or a plurality of small magnetic panels. In another possible embodiment, suction cups or other mechanical connectors could be used in conjunction with or in place of the magnetic mount 22.

The storage container 10 can also be waterproof for outdoor use by including a waterproof cover layer 58, such as nylon material or plastic, on the outside of the lid 16, the perimeter wall 14, and the bottom wall 12. In at least one possible embodiment, a seal could be placed around the edge of the lid 16 or the perimeter wall 14.

The storage container 10 is used to store personal items and golf accessories in the golf cart 60. Personal items may include, but are not limited to, a mobile phone, device charging wires, a cigar holder, a cigar cutter, a cigar lighter, a battery charger, a wedding ring, a watch, car keys, batteries for electronics, and a wallet. Golf accessories may include, but are not limited to, a divot repair tool, ball markers, a golf GPS (global positioning system), gloves, a range finder, golf tees, a portable launch monitors, and golf balls. The user, either before or after filling the storage container 10 with items, magnetically couples the magnetic mount 22 to a metallic portion of the golf cart 60, such as the dash compartment 62 or a wire basket 64. The user opens the lid 16 and places personal items or golf accessories or both in respective compartments 26. The user can place a personal electronic device, such as a mobile phone 70, on the wireless charger 20. The user then closes the lid 16. The user can now transport multiple items conveniently in one place, such as, for example, a golf range finder 72, a golf GPS 74, a wallet 76, and keys 78, as shown in the exemplary embodiment in FIG. 2.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A storage container for storing personal items and golf accessories in a golf cart comprising:
a bottom wall;
a perimeter wall, said perimeter wall extending from said bottom wall, said perimeter wall surrounding a storage space;
a lid, said lid being pivotably connected to said perimeter wall to open and close said storage space;
a plurality of dividers, said dividers being positioned in said storage space to divide said storage space into compartments for personal items and golf accessories;
a wireless charger, said wireless charger being positioned in one of said compartments, said wireless charger being configured to wirelessly charge a personal electronic device placed on said wireless charger; and
a magnetic mount, said magnetic mount being positioned on said bottom wall, said magnetic mount being configured to magnetically couple to a metallic portion of a golf cart.

2. The storage container of claim 1, wherein:
said dividers include at least one stationary divider and a plurality of movable dividers;
said at least one stationary divider is positioned to extend across said storage space;
said at least one stationary divider is attached to opposing panels of said perimeter wall; and
each of said movable dividers is movable with respect to said perimeter wall and said at least one stationary divider to selectively adjust a size of each of said compartments formed in part by said movable dividers.

3. The storage container of claim 2, wherein:
said bottom wall includes a magnetic plate extending under said movable dividers; and
each of said movable dividers includes a magnetic portion configured to magnetically couple to said magnetic plate of said bottom wall such that said movable dividers are selectively positionable on said bottom wall.

4. The storage container of claim 3, wherein:
said perimeter wall includes a front wall panel, a back wall panel, a first side wall panel, and a second side wall panel;
each of said first side wall panel and said second side wall panel is positioned perpendicular to and connecting said front wall panel and said back wall panel;
said lid is pivotably attached to said back wall panel;
said at least one stationary divider comprises a first stationary divider and a second stationary divider positioned perpendicular to and extending between said front wall panel and said back wall panel;
said wireless charger is positioned between said first stationary divider and said first side wall panel;
said movable dividers include central dividers positioned perpendicular to and between said first stationary divider and said second stationary divider and side dividers positioned perpendicular to and between said second stationary divider and said second side wall panel.

5. The storage container of claim 4, wherein each of said central dividers is greater in width than each of said side dividers.

6. The storage container of claim 1, wherein:
said wireless charger includes a battery and a charge port connected to said battery; and
said charge port is positioned in said perimeter wall.

7. The storage container of claim 1, wherein said wireless charger is attached to at least one of said bottom wall and said perimeter wall.

8. The storage container of claim 1, wherein said wireless charger is configured to occupy approximately half of its respective one of said compartments, such that a mobile phone is positionable on said wireless charger and under said lid when closed.

9. The storage container of claim 1, wherein said magnetic mount includes a pair of magnetic strips attached to said bottom wall.

10. The storage container of claim 1, further comprising a waterproof cover layer being positioned on each of said lid, said perimeter wall, and said bottom wall.

11. The storage container of claim 5, wherein:
said wireless charger includes a battery and a charge port connected to said battery; and
said charge port is positioned in said perimeter wall.

12. The storage container of claim 11, wherein said wireless charger is attached to at least one of said bottom wall and said perimeter wall.

13. The storage container of claim 12, wherein said wireless charger is configured to occupy approximately half of its respective one of said compartments, such that a mobile phone is positionable on said wireless charger and under said lid when closed.

14. The storage container of claim 13, wherein said magnetic mount includes a pair of magnetic strips attached to said bottom wall.

15. The storage container of claim 14, further comprising a waterproof cover layer being positioned on each of said lid, said perimeter wall, and said bottom wall.

16. A method of storing personal items and golf accessories in a golf cart, said method comprising the steps of:
providing a storage container comprising:
a bottom wall;
a perimeter wall, said perimeter wall extending from said bottom wall, said perimeter wall surrounding a storage space;
a lid, said lid being pivotably connected to said perimeter wall to open and close said storage space;
a plurality of dividers, said dividers being positioned in said storage space to divide said storage space into compartments for personal items and golf accessories;
a wireless charger, said wireless charger being positioned in one of said compartments, said wireless charger being configured to wirelessly charge a personal electronic device placed on said wireless charger; and
a magnetic mount, said magnetic mount being positioned on said bottom wall, said magnetic mount being configured to magnetically couple to a metallic portion of a golf cart;
magnetically coupling said magnetic mount to a metallic portion of a golf cart;
opening said lid and placing at least one of personal items and golf accessories in at least one of said compartments;
placing a personal electronic device on said wireless charger; and
closing said lid.

17. The method of claim 16, wherein said step of placing at least one of personal items and golf accessories in at least one of said compartments comprises placing at least one golf accessory and at least one personal item each in a respective one of said compartments.
